(19) United States
(12) Patent Application Publication
(10) Pub. No.: US 2016/0329006 A1
(43) Pub. Date: Nov. 10, 2016

(54) INTERACTIVE INTEGRATED DISPLAY AND PROCESSING DEVICE

(71) Applicant: MICROSOFT TECHNOLOGY LICENSING, LLC, Redmond, WA (US)

(72) Inventors: Karon Weber, Kirkland, WA (US); Federico Zannier, Seattle, WA (US); Lorenz Henric Jentz, Seattle, WA (US); Matthew James Schoenholz, Seattle, WA (US); Jean-Louis Villecroze, Redmond, WA (US); Jessica May Michaels, Seattle, WA (US); Terry Sutherland, Woodinville, WA (US)

(73) Assignee: MICROSOFT TECHNOLOGY LICENSING, LLC, Redmond, WA (US)

(21) Appl. No.: 14/703,637

(22) Filed: May 4, 2015

(51) Int. Cl. G09G 3/00; G06F 3/0487; G09G 5/12; G06F 3/0484; G06F 3/03; G06F 3/01

(52) U.S. Cl. CPC G09G 3/002; G06F 3/0304; G06F 3/017; G06F 3/011; G09G 5/12; G06F 3/04845; G06F 3/0487; G09G 2354/00

(57) ABSTRACT

An integrated processing and projection device adapted to rest on a supporting surface provides interactivity between users in a projected display area projected by the device on the supporting surface. The integrated processing and projection device includes a processor and a projector designed to provide a display in the display area. Various sensors enable object and gesture detection in the display area. An interactive service, provided using the device or a network connected host, enables users of companion processing devices to interact in the display area of the integrated processing and projection device using the companion devices, via an interface in the display provide by the projector. Users without companion devices can interact with users of companion devices using an interface provided in the display area.

### BACKGROUND

The capabilities of computing devices have continuously expanded to include ever more capabilities and convenience. From personal computers integrated with monitors to wearable computers, computing devices have progressed toward integrated devices. Each of such integrated computing devices presents a unique set of problems which must be overcome to provide a truly integrated and natural computing experience.

Often, users of computing devices need to share information with other users and collaborate on common information. Various information sharing services allow users of their computing devices to exchange information. Many services provide some form of visualization for this information exchange.

### SUMMARY

The technology, roughly described, includes an integrated processing and projection device which can rest on a supporting surface provides interactivity between users. The interactivity is provided in a projected display area projected by the device on the supporting surface. The integrated processing and projection device includes a processor and a projector designed to provide a display on the supporting surface of the device. Various sensors enable object and gesture detection in the display area. An interactive service, provided using the device or a network connected host, enables users of companion processing devices to interact in the display area of the integrated processing and projection device using the companion devices, via an interface in the display provide by the projector. Users without companion devices can interact with users of companion devices using an interface provided in the display area.

An integrated processing system includes a display projector provided in a housing adapted to be supported by a surface. The display projector is adapted to display an interface in a display area on the supporting surface. The system includes an RGB camera and an infrared emitter and detector, wherein the RGB camera and the infrared detector each have a field of view encompassing a detection area including at least the display area. The system includes a communication interface receiving input and providing output to associated devices. The system includes a processor and memory having code operable to instruct the processor to receive input from one or more associated devices via the communication interface, the input comprising at least data to be shared in the display area, and provide an output in the display area of the data to be shared based on input instructions from the one or more associated devices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a perspective view of an integrated processing and projection device on a supporting surface.

FIG. 2 depicts a side view of the integrated processing and projection device.

FIG. 3 is a block diagram depicting the internal components of the integrated processing and projection device.

FIGS. 4A through 4C illustrate the expansion of the projection system in the integrated processing and projection device.

FIG. 5 is a partial side view of a second embodiment of an integrated processing and projection device.

FIG. 6A is a block diagram illustrating a collaboration service utilized with the integrated processing and projection device as well as associated processing devices.

FIG. 6B is a block diagram illustrating a collaboration service utilizing associated processing devices with the integrated processing and projection device.

FIG. 7 is a perspective view of the integrated processing projection device with a physical object in the display area.

FIG. 8A is a perspective view of two users interacting with the integrated processing and projection device, each user having an associate a processing device.

FIG. 8B is a perspective view of two users interacting with the integrated processing and projection device in the projection area.

FIG. 8C is a depiction of one type of user interface for interaction using data from different users.

FIG. 9 is an illustration of an exemplary application utilized with the integrated processing and projection device.

FIGS. 10A through 10c are an illustration of a second exemplary application utilized with the integrated processing and projection device

FIG. 11 is a perspective view of an alternative application and projection surface utilized with the integrated processing and projection device.

FIG. 12 is a flowchart illustrating a first computer implemented method in accordance with the present technology.

FIG. 13 is a flowchart illustrating interaction of associated devices with the integrated processing and projection device.

FIG. 14 an exemplary collaboration application utilized with the integrated processing projection device.

FIG. 15 is a block diagram illustrating the components of an associated processing device.

### DETAILED DESCRIPTION

Technology is presented wherein an integrated processing and projection device adapted to rest on a supporting surface provides interactive applications alone or in conjunction with associated processing devices in a projected display area on the supporting surface. In one aspect, interaction between multiple users is enabled by an integrated processing and projection device, or a hosted service designed to enable interaction in conjunction with an integrated processing and projection device. The integrated processing and projection device includes a processor and a projector designed to provide a display on the supporting surface of the device. Various sensors enable object and gesture detection in the display area. An interactive service, provided using the device or a network connected host, enables users of companion processing devices to interact in the display area of the integrated processing and projection device using the companion devices, via an interface in the display provide by the projector. Users without companion devices can interact with users of companion devices using an interface provided in the display area.

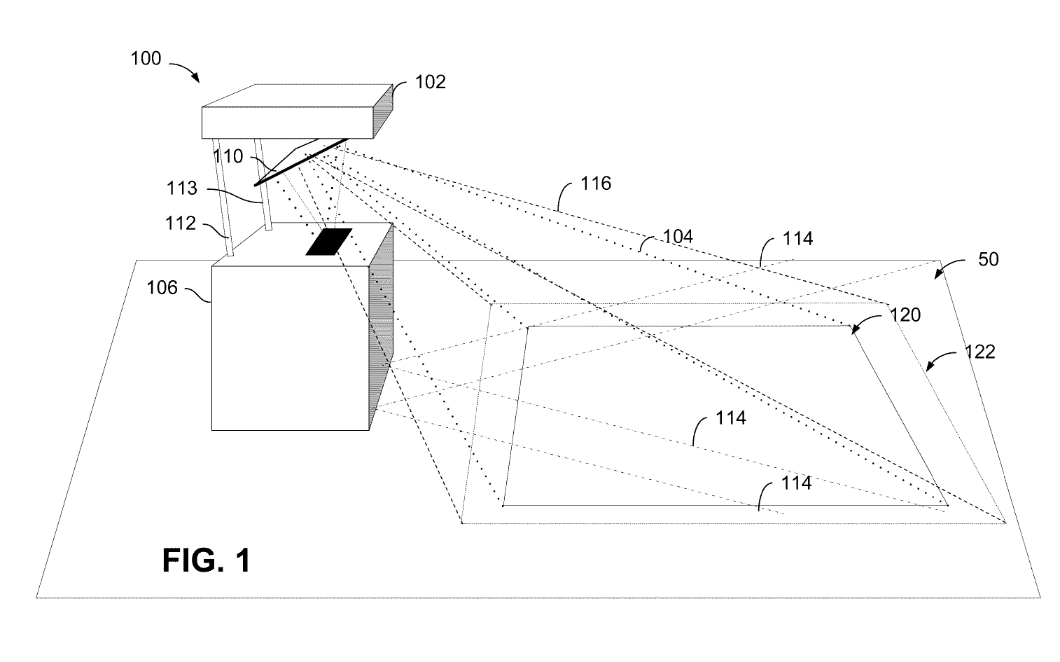

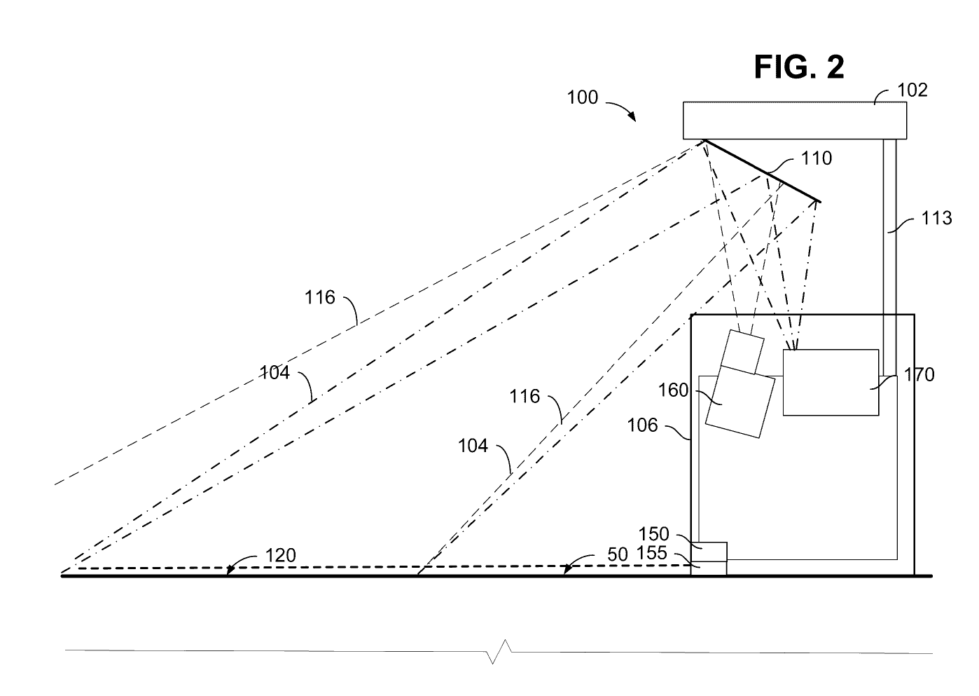

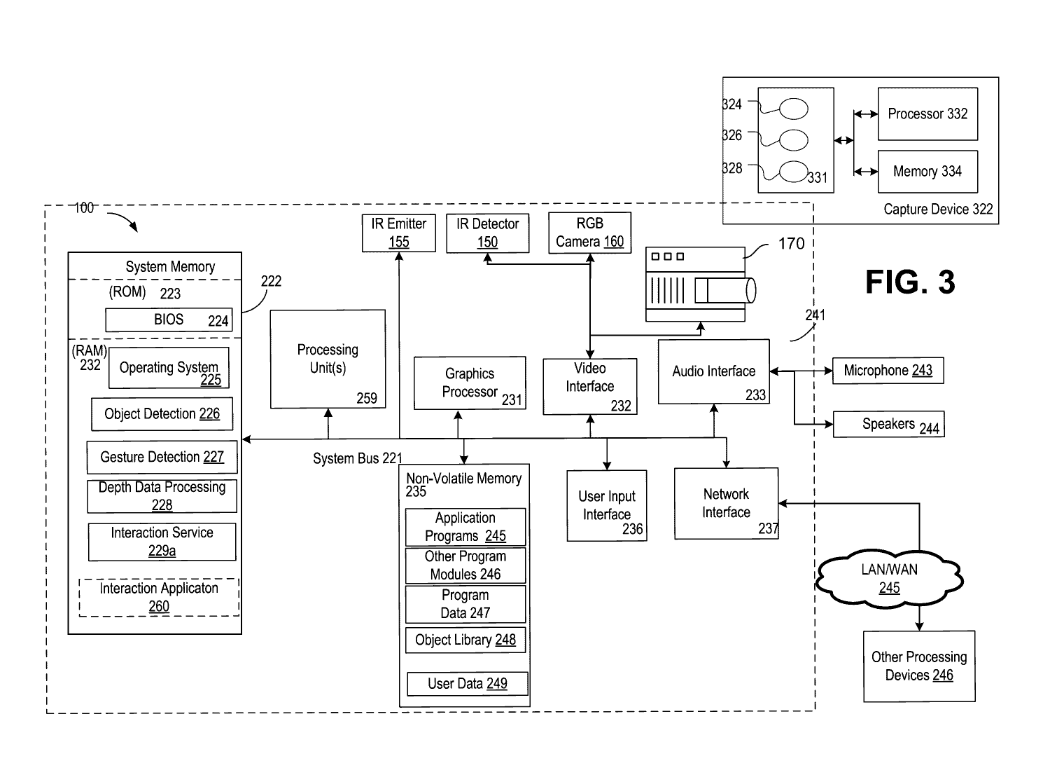

FIG. 1 illustrates a perspective view of an interactive processing and projection device 100. Interactive processing and projection device 100 will be described with respect to the various figures herein. FIG. 2 is a side view of the device 100 and FIG. 3 is a block diagram illustrating various components of device 100.

As illustrated in FIGS. 1-3, a first embodiment of an integrated processing and projection device 100 is designed to be supported on a supporting surface 50 and to project into a display area 120 various interfaces and interactive displays. Interfaces may be projected and used in the display area 120, with objects and gestures of users which occur in the display area being detected by various sensors and a processor in housing 106. Device 100 includes, in one embodiment, a projector 170, and sensors including an RGB camera 160, an infrared emitter 155 and an infrared detector or camera 150, all provided in housing 106. The sensors detect interactions in a detection area 122 which encompasses the display area 120. The housing 106 may be supported by any supporting surface 50 and may project a display area 120 onto the supporting surface or other surfaces as described herein. Various components provided in housing 106 are illustrated in FIG. 3.

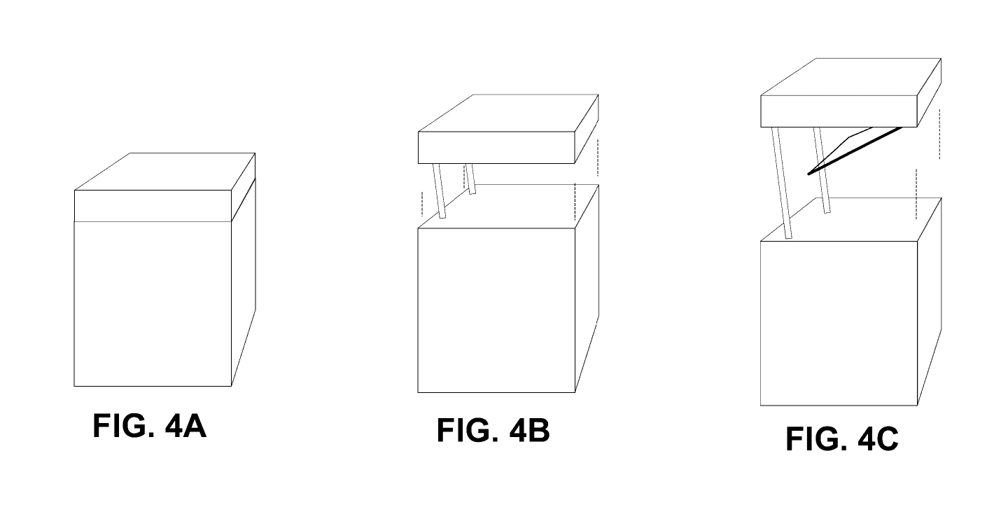

Housing 106 includes a lid 102 having mounted therein a rotatable mirror 110. Lid 102 is supported by arms 112, 113 which can raise and lower lid 102 as illustrated in FIGS. 4A through 4C. Arms 112, 113 are connected to lid 102 at one end and motors (not shown) provided in the housing 106 which operate to raise and lower the lid. Mirror 110 in lid 102 provides both an output for the projector 170 and reflects the display area 120 into a field of view for RGB camera 160. FIG. 4A illustrates the closed position of the device 100, FIG. 4B illustrates a partially raised lid 102 and FIG. 4C illustrates a fully raised lid 102 with mirror 110 rotated into a fully extended position. Mirror 110 can be mounted on a spring-loaded hinge or mounted to a motor and hinge (not shown) to allow extension and retraction of the mirror 110 between the open and closed positions illustrated in FIGS. 4C and 4A respectively. The housing is designed to be portable, with a height in the range of 8 inches-30 inches and a width of 4 inches-15 inches. Any number of various configurations are possible, allowing the device 100 to turn any surface into an interactive canvas.

As illustrated in FIGS. 1 and 2, infrared emitters which may comprise infrared light emitting diodes (LEDs) illuminate a detection area 122 which in one embodiment is larger than the display area 120. Emitters 155 are mounted near the bottom of the housing 106 so as to illuminate an area of the supporting surface in the display area 120 adjacent to the supporting surface 50. IR illumination represented at 114 illuminates any object close to the surface 50 in the projection area 122 and is useful in detecting surface interactions by objects and user hands. Projector emissions 104 from the projector 170 illuminate the projection area 122 with visible light. The field of view 116 of camera 160 may be larger than the projection area 122 and encompass the detection area 122.

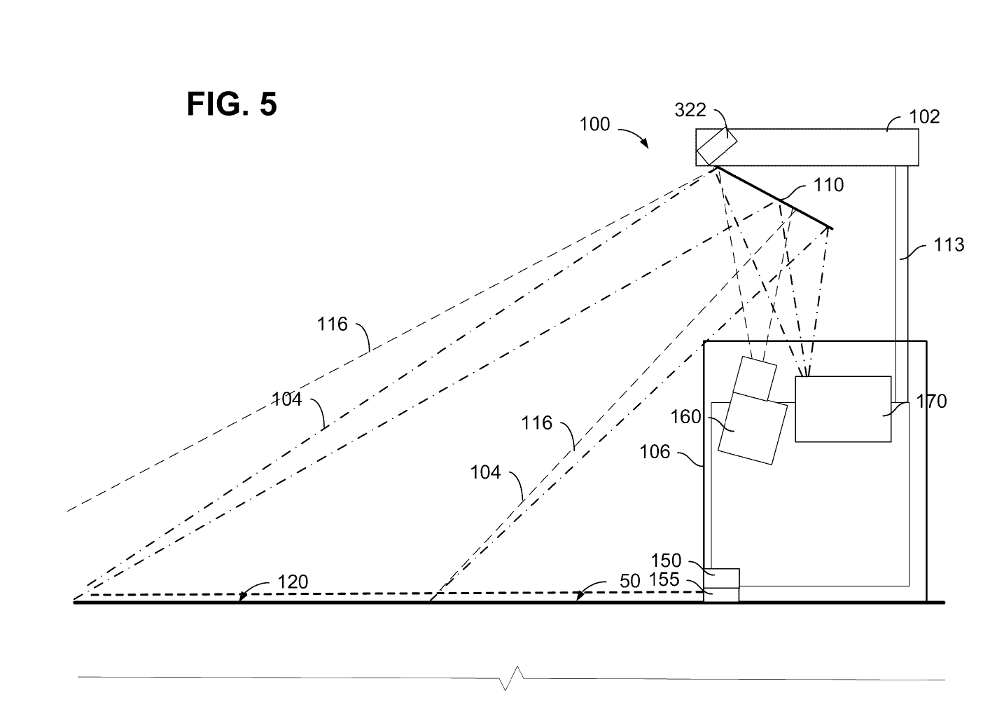

A second embodiment of device 100 is illustrated in FIG. 5. The embodiment of FIG. 5 includes the components of the embodiment of FIGS. 1-2 and further includes a capture device 322. The capture device may be positioned in a manner that it is focused at the detection area 122, or may alternatively have other positions and be directed to detect and track users who are proximate to device 100.

FIG. 3 illustrates the components which may be included in the both embodiments of the device 100. Differences between the respective embodiments will be noted where applicable. (For example, in FIG. 3, a capture device 322 is illustrated but it should be understood that in one embodiment such as that illustrated with respect to FIGS. 1 and 2, no capture device need be used.) The components of device 100 are one example of a suitable computing environment and is not intended to suggest any limitation as to the scope of use or functionality of the present system. Neither should the device 100 be interpreted as having any dependency or requirement relating to any one or combination of components illustrated in the exemplary device 100.

With reference to FIG. 3, an exemplary device 100 for use in performing the above-described methods includes a one or more processors 259 adapted to execute instructions in the form of code to implement the various methods described herein. Components of computing system 300 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 222 includes computer storage media in the form of volatile and/or nonvolatile memory such as read only memory (ROM) 223 and random access memory (RAM) 231. A basic input/output system (BIOS) 224, containing the basic routines that help to transfer information between elements within device 100, such as during start-up, is typically stored in ROM 223. RAM 231 typically contains data and/or program modules that are immediately accessible to and/or presently being operated on by processing unit 259. By way of example, and not limitation, FIG. 3 illustrates operating system 225, an object detection component 226, a gesture recognition component 227, a depth data processing component 228 (for the embodiment of FIG. 5) and an interaction service component 229a.

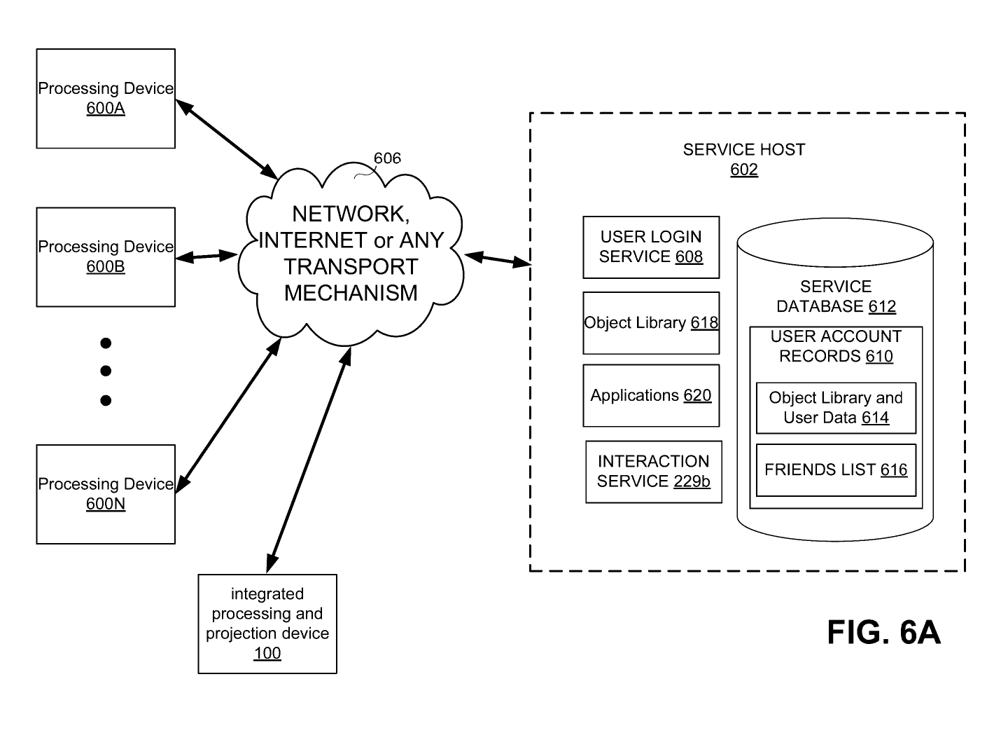

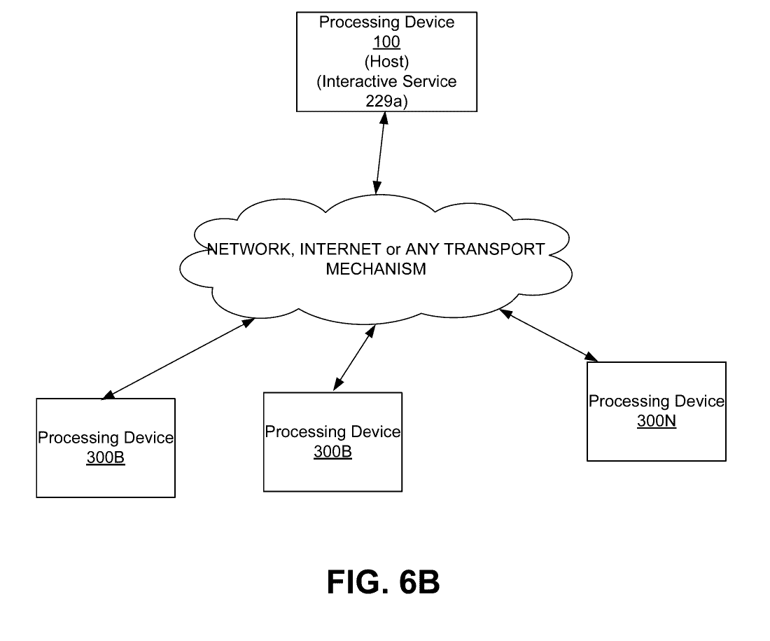

Object detection component 226 includes instructions for enabling the processing units 259 to detect both passive and active objects in the object detection area 122. Gesture recognition component 227 allows detection of user hand and object gestures within the detection area 122. Depth data processing component 228 allows for the depth image data provided by capture device 322 to be utilized in conjunction with the RGB image data and the IR detector data to determine any of the objects or gestures described herein. Interaction service component 229a provides a communication path to allow users with other processing devices to communicate with the device 100 and/or the device 100 to communicate with an interactive service system (illustrated in FIG. 6B). As noted below, the interaction service 229a may optionally or additionally be provided by a network based computing service host 602, where the equivalent service is illustrated at 229b.

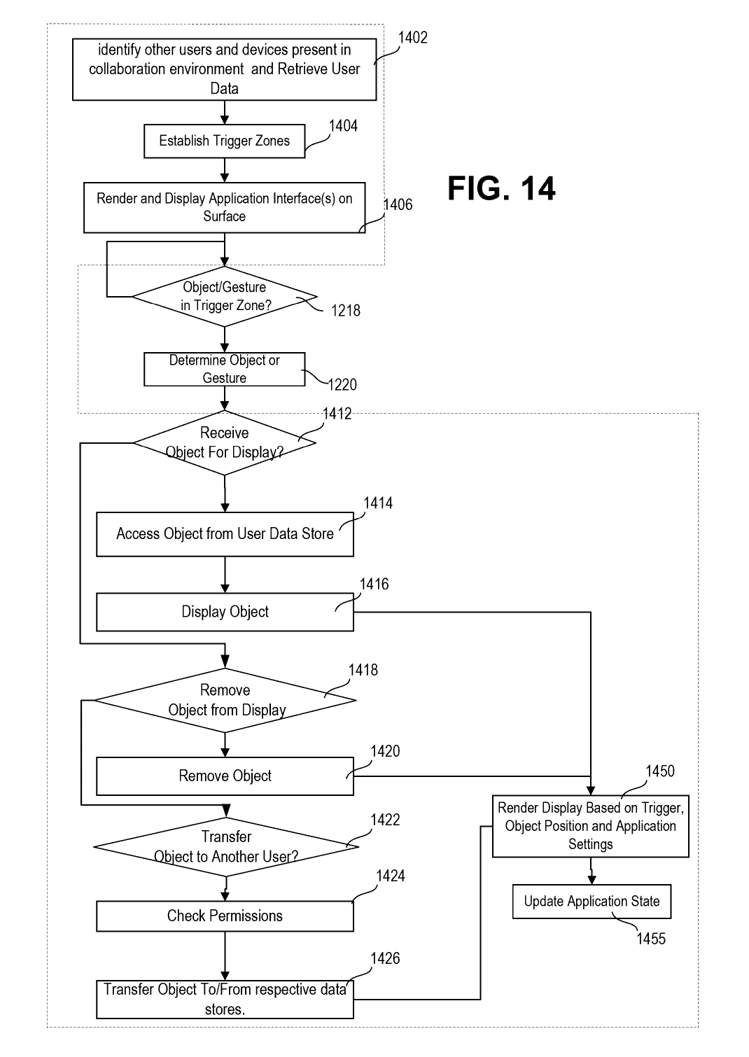

Optionally, an interaction application 260 may be provided to implement the functions of FIG. 14 described herein allowing multiple users to interact with each other in the display area 120 without the use or requirement of a companion processing device associated with the user. A companion processing device associated with the user may be referred to herein as an associated processing device Functions of components 226-229 and 260 will be further described herein.

Device 100 may also include other removable/non-removable, volatile/nonvolatile computer storage media. By way of example only, FIG. 3 illustrates non-volatile memory 235 which may comprise a hard disk drive, solid state drive, or any other removable or non-removable, nonvolatile magnetic media including magnetic tape cassettes, flash memory cards, DVDs, digital video tape, solid state RAM, solid state ROM, and the like. The non-volatile media illustrated in FIG. 3 provide storage of computer readable instructions, data structures, program modules and other data for device 100. In FIG. 3, for example, non-volatile memory 235 is illustrated as storing operating system application programs 245, other program modules 246, and program data 247 another object library 248 and user data 249. Non-volatile memory 235 may store other components such as the operating system and application programs (not shown) for use by processing units 259. A user may enter commands and information into the computer 241 through input interfaces projected into the detection area 122, or through conventional input devices such as a keyboard and pointing device. These and other input devices are often connected to the processing unit 259 through a user input interface 236 that is coupled to the system bus, but may be connected by other interface and bus structures, such as a parallel port, game port or a universal serial bus (USB).

The computer 241 may operate in a networked environment using logical connections to one or more remote computers, such as a remote computer 251. The remote computer 251 may be a personal computer, a server, a router, a network PC, a peer device or other common network node. The logical connections depicted include a local area network (LAN) and a wide area network (WAN) 245, but may also include other networks. Such networking environments are commonplace in offices, enterprise-wide computer networks, intranets and the Internet. When used in a LAN networking environment, the computer 241 is connected to the LAN/WAN 245 through a network interface or adapter 237.

The RGB camera 160 and IR detector 150 may be coupled to a video interface 232 which processes input prior to input to the processing units 259. A graphics processor 231 may be utilized to offload rendering tasks from the processing units 259. IR Emitter 150 operates under the control of processing units 259. Projector 170 is coupled to video interface 232 to output content to the display area 120. Video interface 232 operates in conjunction with user input interface 236 to interpret input gestures and controls from a user which may be provided in the display area 120.

A user may enter commands and information into the device 100 through conventional input devices, but optimally a user interface is provided by the projector 170 into the display area 120 when input is utilized by any of the applications operation on or in conjunction with device 100.

A capture device 322 may optionally be provided in one embodiment as shown in FIG. 5. Capture device 322 includes an image camera component having an IR light component 324, a three-dimensional (3-D) camera 326, and a second RGB camera 328, all of which may be used to capture the depth image of a capture or detection area 122. The depth image may include a two-dimensional (2-D) pixel area of the captured scene where each pixel in the 2-D pixel area may represent a depth value such as a distance in, for example, centimeters, millimeters, or the like of an object in the captured scene from the image camera component 331.

In time-of-flight analysis, the IR light component 324 of the capture device 322 may emit an infrared light onto the capture area and may then use sensors to detect the backscattered light from the surface of one or more objects in the capture area using, for example, the 3-D camera 326 and/or the RGB camera 328. In some embodiments, pulsed infrared light may be used such that the time between an outgoing light pulse and a corresponding incoming light pulse may be measured and used to determine a physical distance from the capture device 322 to a particular location on the one or more objects in the capture area. Additionally, the phase of the outgoing light wave may be compared to the phase of the incoming light wave to determine a phase shift. The phase shift may then be used to determine a physical distance from the capture device to a particular location associated with the one or more objects.

In another example, the capture device 20 may use structured light to capture depth information. In such an analysis, patterned light (i.e., light displayed as a known pattern such as grid pattern or a stripe pattern) may be projected onto the capture area via, for example, the IR light component 324. Upon striking the surface of one or more objects (or targets) in the capture area, the pattern may become deformed in response. Such a deformation of the pattern may be captured by, for example, the 3-D camera 326 and/or the RGB camera 328 and analyzed to determine a physical distance from the capture device to a particular location on the one or more objects. Capture device 322 may include optics for producing collimated light. In some embodiments, a laser projector may be used to create a structured light pattern. The light projector may include a laser, laser diode, and/or LED.

The capture device 322 may include a processor 332 that may be in communication with the image camera component 331. The processor 332 may include a standardized processor, a specialized processor, a microprocessor, or the like. The processor 332 may execute instructions that may include instructions for receiving and analyzing images. It is to be understood that at least some image analysis and/or target analysis and tracking operations may be executed by processors contained within one or more capture devices such as capture device 322.

The capture device 322 may include a memory 334 that may store the instructions that may be executed by the processor 332, images or frames of images captured by the 3-D camera or RGB camera, filters or profiles, or any other suitable information, images, or the like. As depicted, the memory 334 may be a separate component in communication with the image capture component 331 and the processor 332. In another embodiment, the memory 334 may be integrated into the processor 332 and/or the image capture component 331.

The capture device 322 may be in communication with the device 100 via a communication link. The communication link 46 may be a wired connection including, for example, a USB connection, a FireWire connection, an Ethernet cable connection, or the like and/or a wireless connection such as a wireless 802.11b, g, a, or n connection.

The cameras 326, 328 and capture device 322 may define additional input devices for the device 100 that connect via user input interface 236. In addition, device 100 may incorporate a microphone 243 and speakers 244 coupled to an audio interface 233.

As noted above, an interaction service may allow users of companion processing devices associated with the user to interact with the device 100 and in the display area 120, providing a common interaction zone for both users of companion devices and users of the device 100 directly.

FIGS. 6A and 6B illustrate two alternatives providing an interactive service 229 allowing users of the integrated processing a projection device 100 to interact with users where at least one user has a companion processing device associated with that user. Examples of various alternatives of sharing and gaming interaction applications which may be provided on the integrated processing and projection device 100, as well as those which may be utilized in conjunction with associated processing devices of other users, are described below.

FIG. 6A illustrates an embodiment where in a service host 602 provides interactivity between the integrated processing and projection device 100 and any number of associated processing devices 600A, 600B, and 600N. The service host 602 may be provided by any number of processing devices (servers) though which communication with respective devices 100 and 600 is enabled. In FIG. 6A, each of the processing devices 600A, 600B and 600N may comprise any form of personal computer, tablet, mobile device, wearable processor, or integrated processing and projection devices. Each such associated device is illustrated as connecting to a service host 602 via a network 606. The network 606 may be any form of public or private network, or data transport mechanism.

Service host 602 may include, for example, a user login service 608, an object library 618, applications 620, and interaction service 229b. Service database 612 may include user account records 610 having a user-associated object library and user data 614 and a friends or associates list 616. The service host 602 may be utilized to provide applications running on either the processing devices 600 or the integrated processing and projection device 100 with the means to communicate objects from user data 614 or the individual devices 600 and 100 and their respective applications to each other and to a common display environment such as the display area 120 of the integrated processing and projection device 100. Users of processing devices 600 and projection device 100 may utilize any of a variety of applications to share information in a common display area 120, or between individual associated processing devices, based on permissions defined and stored in the user account records 610. The login service 608 ensures that each user of the collaboration services and the user's associated device is authorized and authenticated. Object library 618 may provide information to the integrated processing and projection device 100 to regarding real objects which may be placed in the display area 120 as well as the identity of associated processing devices of users of service host 602. Interaction service 229b utilizes the identities of users and associated processing devices to enable information sharing between both of processing devices 600 and the integrated processing and projection device 100. The interaction service can utilize sensors described above on the integrated processing and projection device 100 to identify companion processing devices which are proximate to the integrated processing and projection device 100 to thereby enable communication and interaction between the respective devices.

Applications 620 may comprise executable instructions for any of the processing devices 600 and integrated processing and projection device 100 which may be utilized by the devices 100 and 600 to participated in the interaction service 229b as described in the examples herein.

User interaction history and permissions may be stored in the object library and user data 614 and friends list 616. For example, where a user has identified certain physical objects in the display area and preferences regarding such objects, this information is stored in the object library and user data 614. library and user data 614 may also include user-specific data that a user wishes to use in the interaction service. For example, data such as documents and notes may be retained securely in the user data 614 and accessed by the user when interacting with the collaboration service. The friends and associates list 616 can store permissions of the types of information which may be available through various applications for users of respective processing devices 600 and device 100.

FIG. 6B illustrates an alternative wherein processing devices 600 interact with the integrated processing and projection device 100 using an interactive service hosted by an integrated processing and projection device 100. In this embodiment, the integrated processing and projection device 100 provides similar services which are available to provide the collaboration and interaction described herein, but no such server-based host service utilized. Applications running on associated processing devices 600 may access a service available from the device 100 through an application programming interface allowing data to be transferred bi-directionally between the respective devices.

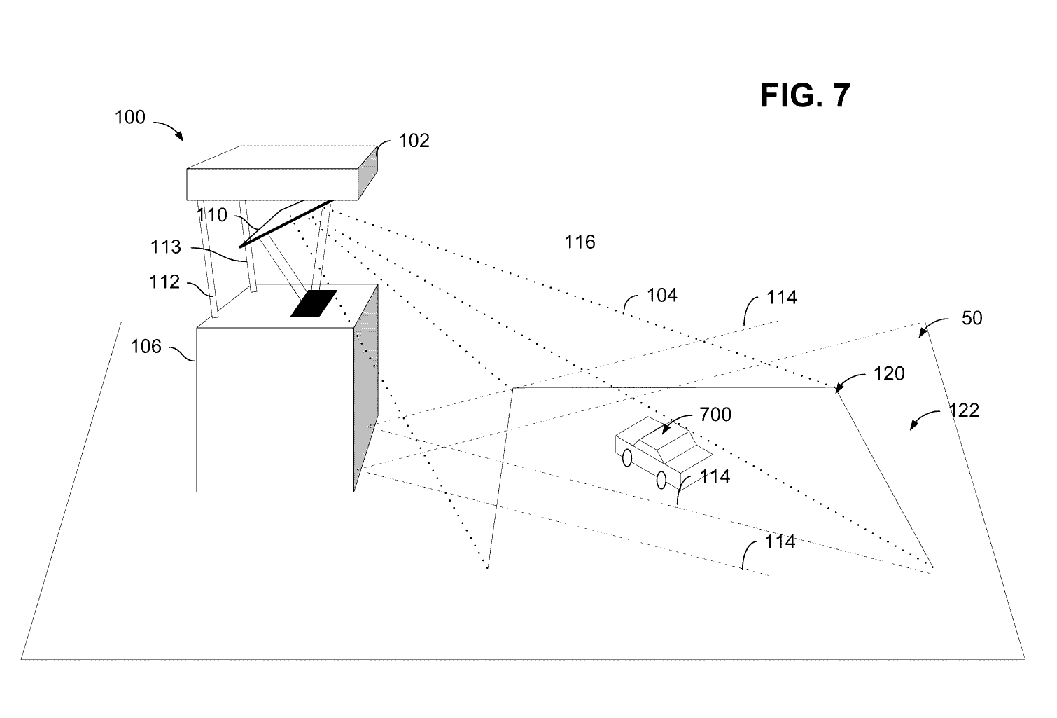

As noted herein, device 100 may utilize sensors including IR detector 150 and camera 160 (and optionally, capture device 322) to identify objects in a detection area 122. Device 100 may also identify other devices and users via communication with the device 100 or using the above sensors. FIG. 7 illustrates one example where in an object has been placed in the display area 120 of the integrated processing a projection device 100. As illustrated therein, the objects 700 will be in view of the RGB camera and the IR detector. Using object recognition techniques, the object 700 can be identified by the device 100.

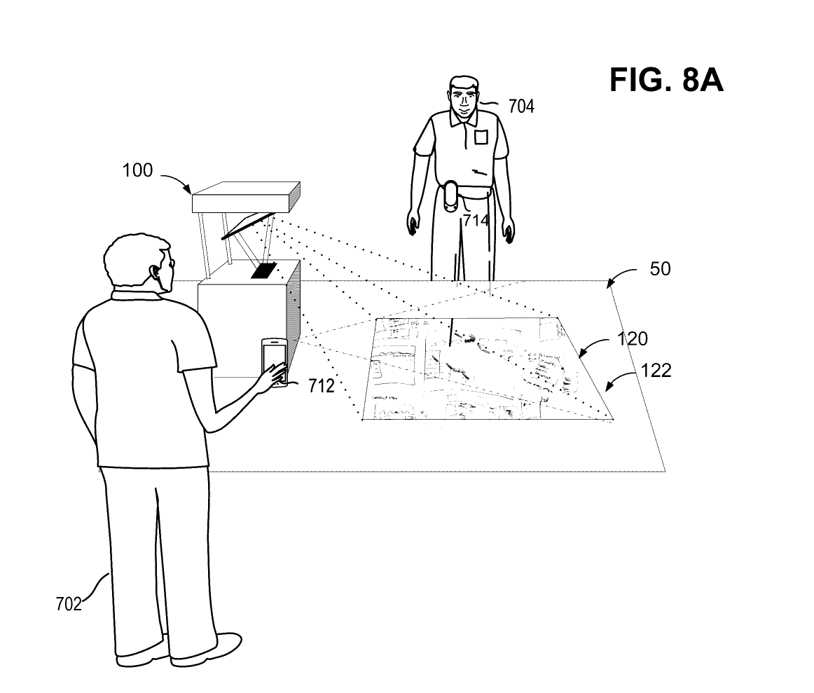

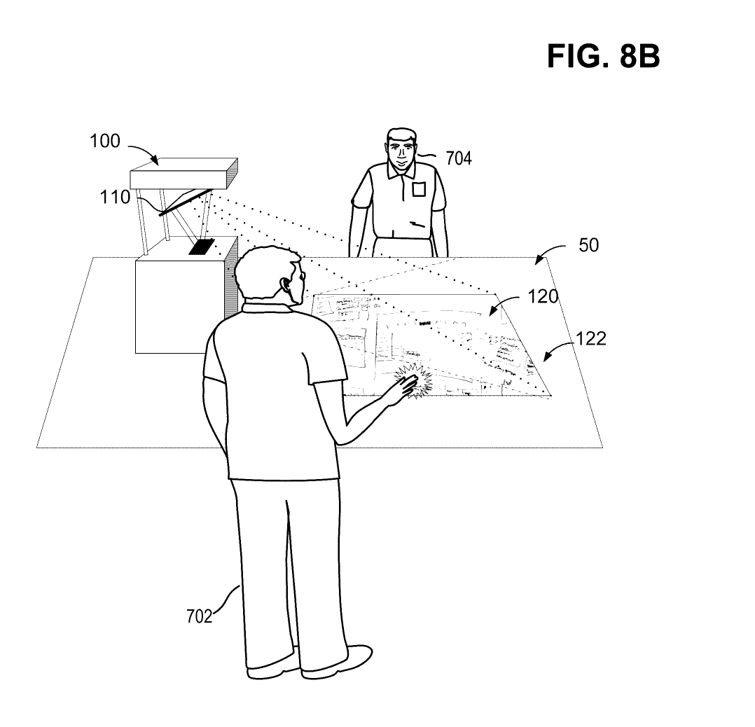

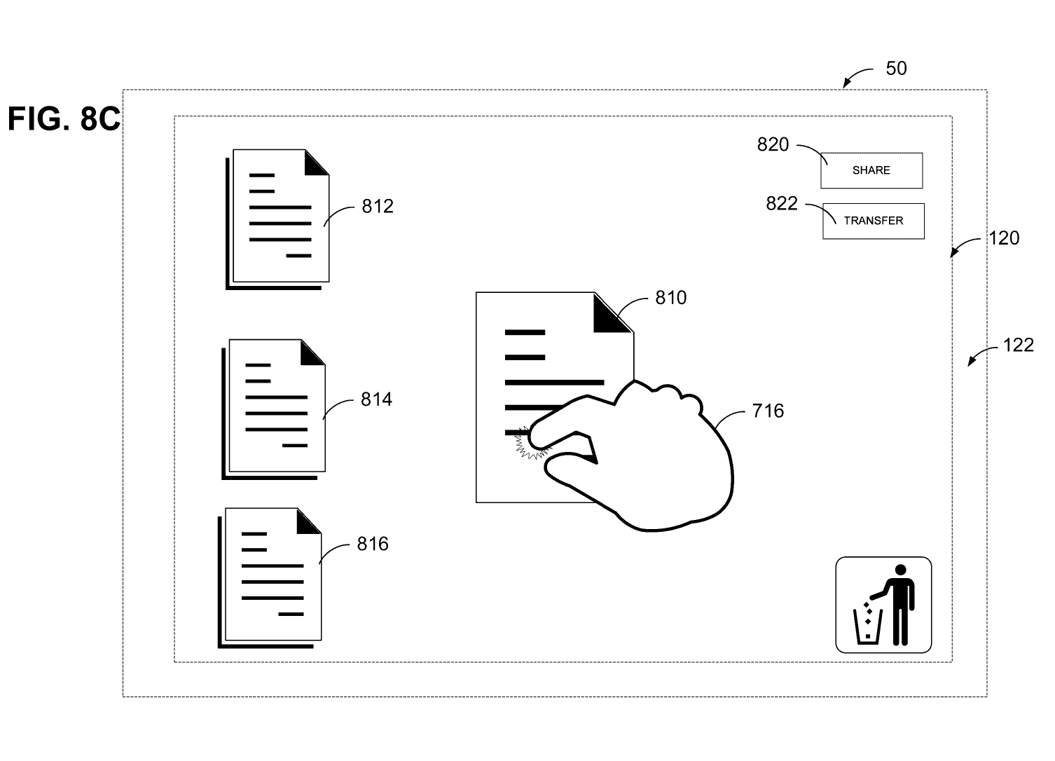

FIG. 8A illustrates an embodiment wherein two users 702, 704, each having an associated processing devices 712, 714, respectively approach the supporting surface 50 and the integrated processing and projection device 100. Using any of a number of techniques, the integrated processing and projection device can determine that user 712, 714 are proximate to device 100 and allow their associated processing devices 712, 714 to interact with both device 100 and each other via the interaction service 229 (229a or 229b). In the example shown FIG. 8A, user 702 is sharing information in the projection area visible for both users 702, 704. The interaction service 229 may determine the proximity of users 702, 704 using location information from the devices 712, 714, by identifying the users after prompting them to input user information in the display area 122 or by communication from the respective devices 712, 714.

FIG. 8B is an illustration of users 702 and 704 interacting with a common display area 120 without the user of associated processing devices but rather using the touch controls in the display area 120. Each item displayed in the display area may comprise a display object representing shared or interactive data provided by one user or a common shared experience, and each display object can be manipulated based on touch input detected by the sensors of device 100. For example, if a document is placed in the display area, the document can be manipulated through a drag-and-drop procedure, swept off of the page in the display area, or other matters, using the type of gestures which are now common to touch interface displays. FIG. 8C illustrates a user hand 716 applying a touch gesture to a projected document 810 in display area 120. The document display object can be “grabbed” using a pinch gesture, for example, and dragged or placed in one or more “stacks” display objects 812, 814, 816 representing user data objects such as data stores or file systems for which the user has access permissions. Interface elements 820 and 822 may be operable to instruct the device 100 to control sharing and transfer or other functions for the data objects between user data stores and user devices.

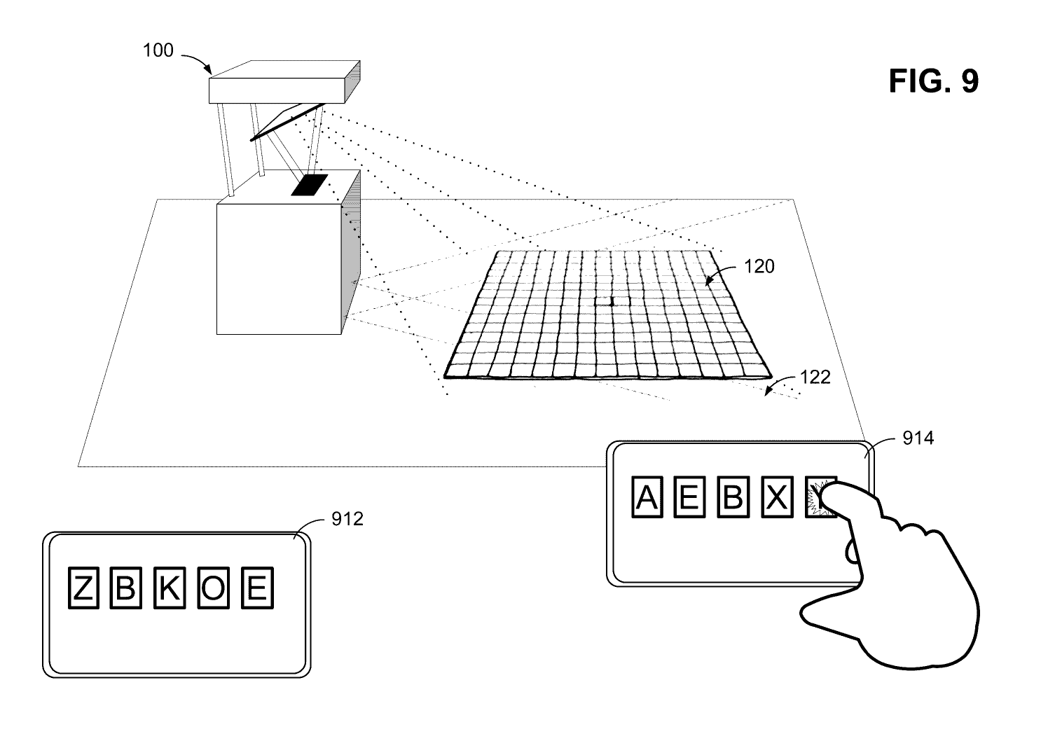

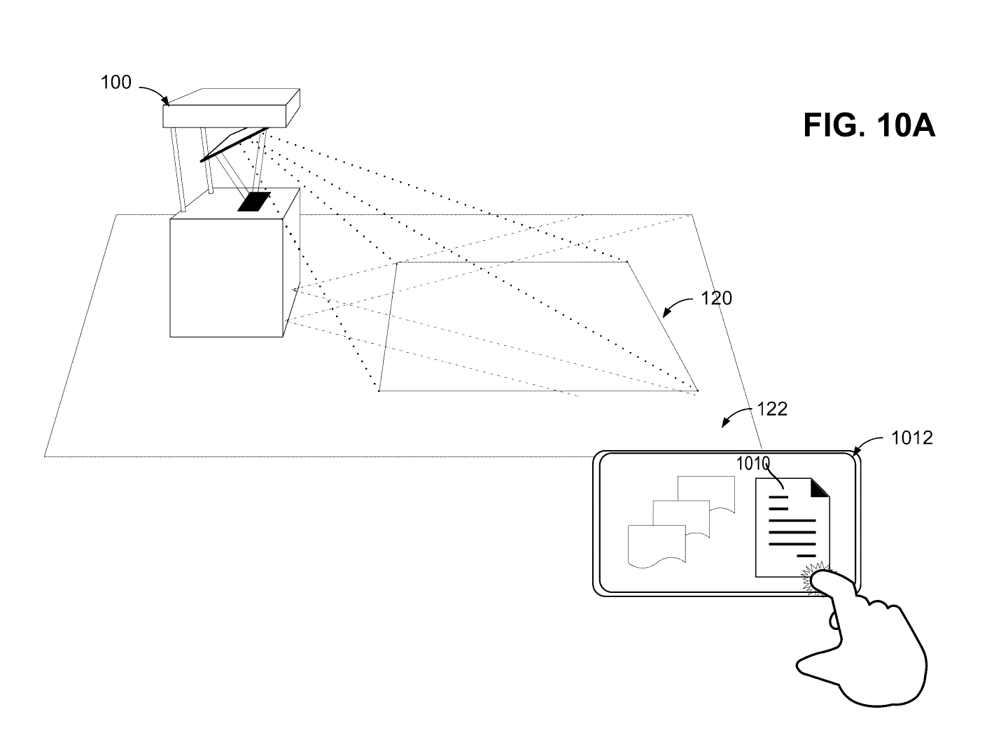

FIG. 9 illustrates another example of multiple associated processing devices 912 and 914 interacting with device 100. In this example, an interactive application 260 may allow device 100 to provide a shared game of “Scrabble(R)”, with each respective processing device 912, 914 including a user's playing tiles, and a display area 120 includes the common board game display object on which users play the tiles. It should be understood that the interactive application 260 may likewise be provided on either device 912 or 914 and the devices communicate with device 100 using the interaction service 229a or 229b. When a particular tile is selected are processing device, either by a swipe gesture or other touch interface gesture, the tile can be moved to the common display area 120. Similarly, tiles can be removed from the display area to the individual processing device by a return gesture.

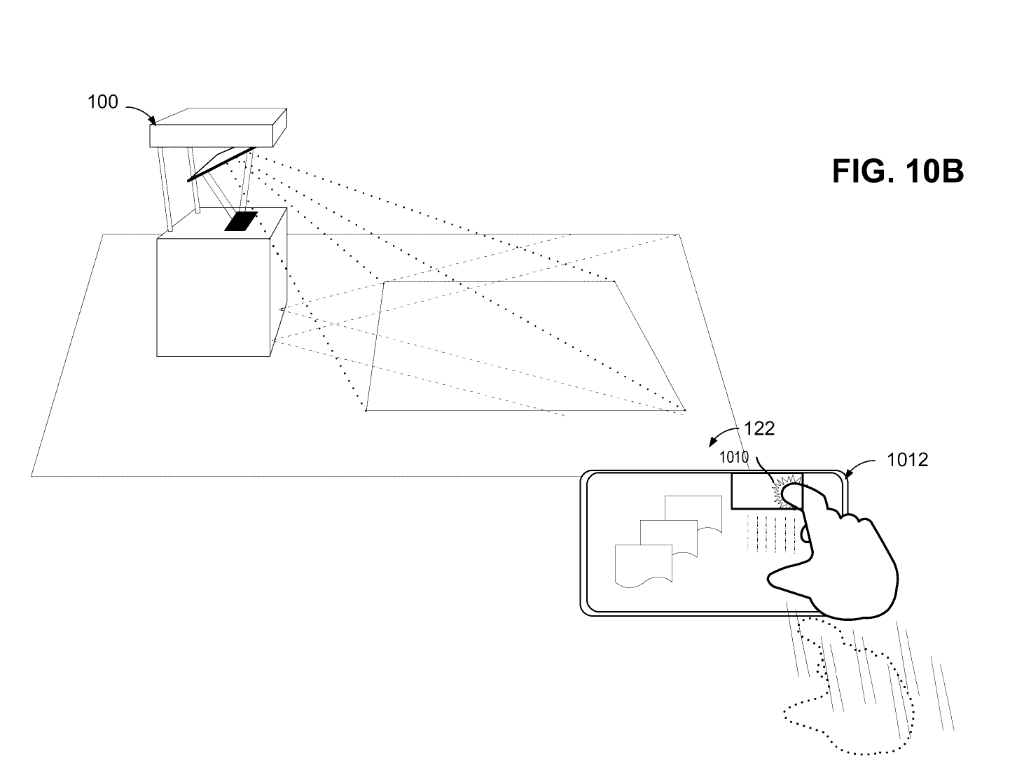

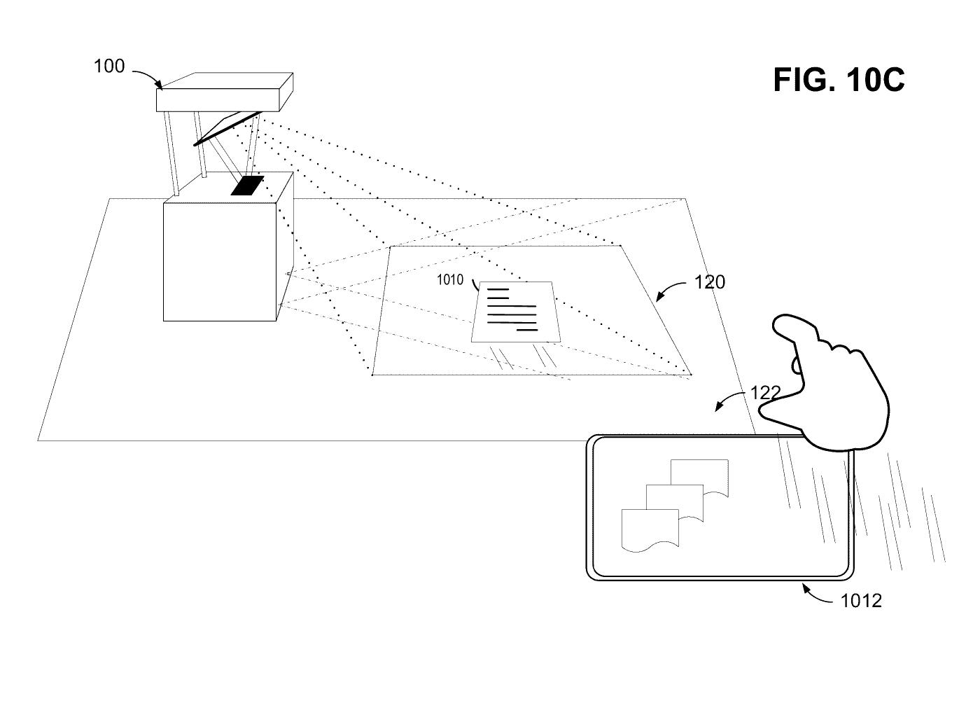

FIGS. 10A through 10C illustrate how a document or other object utilized in a sharing application on an associated processing device may be provided into the common display area using a swipe gesture on a processing device 1012. A selected document 1010 is displayed on the processing device 1012. For illustration, processing device 1012 has a touch interface display; however, it should be understood that the particular control mechanism used to move the document into the display area 120 is exemplary only and any form of input command to an associated device may instruct the device 1012, device 100 and service 229 to move the data as exemplified herein into the common display area 120. As illustrated in FIG. 10A, when a user selects a particular document 1010 on the processing device 1012, user then swipes forward as illustrated in FIGS. 10B and 10C toward the display area 120. This results in the document 1010 appearing as a display object in the common display area 120 of FIG. 10C. Animation effects can illustrate the motion of the document as appearing in the display area 120. In one embodiment, user input merely displays a copy of the document; in other embodiments, the document may be transferred to storage on device 100 or multiple copies of the document may be stored. The particular nature of document (or any object) manipulation may be defined by the interactive application being utilized.

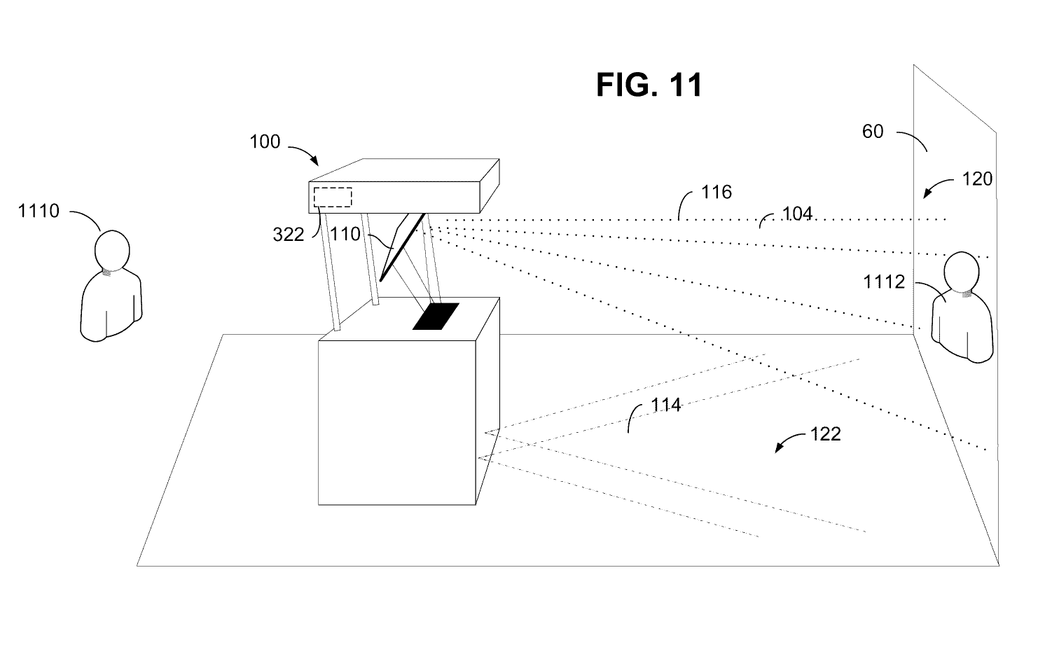

Other types of interactive applications need not use service 229 or proximate associated processing devices. FIG. 11 illustrates an alternative implementation wherein the projected area 120 is provided on a horizontal surface, rather than a vertical surface. In this application, videoconferencing application such as Skype® can be utilized with the device 100. A change in the angle of the mirror 110 allows the projection area 122 to move to a vertical surface. It should be noted that the mirror rotation will also change the field of view of camera 160 to that a portion of the detection area 122 will be provided on a vertical surface 60. In this application, device 100 may utilize a capture device positioned in the housing designed to capture users (such as user 1110) who are proximate to the device 100. Any number of capture devices positioned in any orientation may be provided to detect users proximate to device 100. An appropriately placed capture device 322 having a second RGB camera may enable both a local user 1110 and remote, projected user 1112 to see each other.

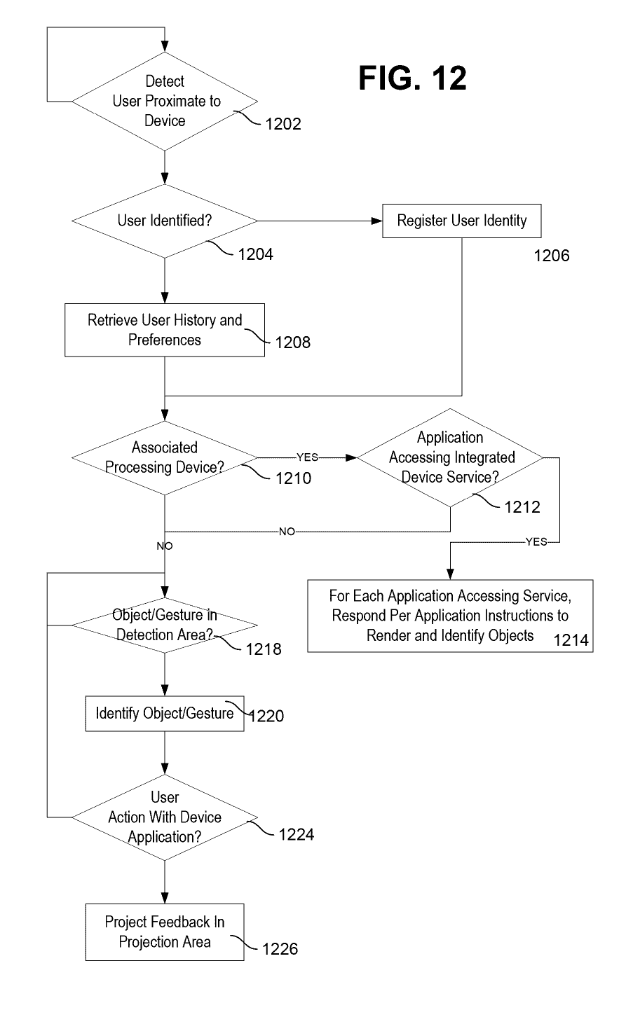

FIG. 12 is a flowchart illustrating providing an interactive service 229a, 229b using a computer implemented method on device 100 or via service host 602. At 1202, a determination is made as to whether a user is proximate to the integrated processing and projection device 100. The determination of whether a user is proximate to the device may be made by evaluating data from any of the above-mentioned sensors, input from a microphone, and/or communication with associated processing devices (i.e. devices 600). Associated processing devices are those which have been associated with a particular user. Hence, if a user's associated processing device is determined to be in a location which is close to the device 100, the test at step 1202 may be affirmative. If no users proximate to the device, the method continues monitoring the area adjacent and around the device 100 until a user appears proximate to the device 100. If the user is detected, the method attempts to determine whether or not the user can be identified at 1204. User identification at step 1204 may be made by reference to the associated device identity or input from the sensors or by specific input in the detection area 122. If the user cannot be identified at 1204, then the user identity is registered at 1206. This allows the system to keep track of which users are accessing the interaction services. If the user is identified a 1204, then user history and preferences (if available) are retrieved at 1208. User history and preferences can allow the device 100 to more accurately identify objects, user preferences regarding objects, and gestures of a particular user when utilizing the interaction service. If the processing device was not previously been detected at step 1202, then at step 1210, a determination is made as to whether or not a user has an associated processing device.

If a user does not have an associate processing device, then an interaction application 260 and the interaction service 229 may still allow the user to participate in interactions using an interface in the display area 120. If a user does have an associated processing device, a determination is made at 1212 as to whether or not the device has an interactive service enabled application which interfaces with the integrated device service. The applications on an associated processing device can access the device 100 and projected area 120, as described above, via service 229 using an application programming interface. If the associated processing device is accessing the integrated device service 229 at step 1212, then for each application accessing the interaction service, device 100 will respond per application instructions to render and identify objects in the display area and the detection area 122.

If no associated processing device is present for a given user at 1210, then the system will monitor the detection area 122 at step 1218 and if at step 1218 an object or gesture is performed or placed in the detection area 122, then the object or gesture is identified at 1220 and at 1224, a determination is made as to whether or not the object or gesture is an interaction with the interaction application. If there is no object or gesture in the detection area, step 1218 loops until such action or object occurs. If so, then feedback regarding the interaction may be projected into the projection area 122 at 1226. If the gesture is not a user action with the interaction application at 1224, the method waits for the next interaction at 1218.

It should be understood that for each device and each user accessing an interaction application, steps 1214 and steps 1218-1226 may operate concurrently and in parallel for so that both users with associated processing devices and those without may concurrently utilize an interaction application.

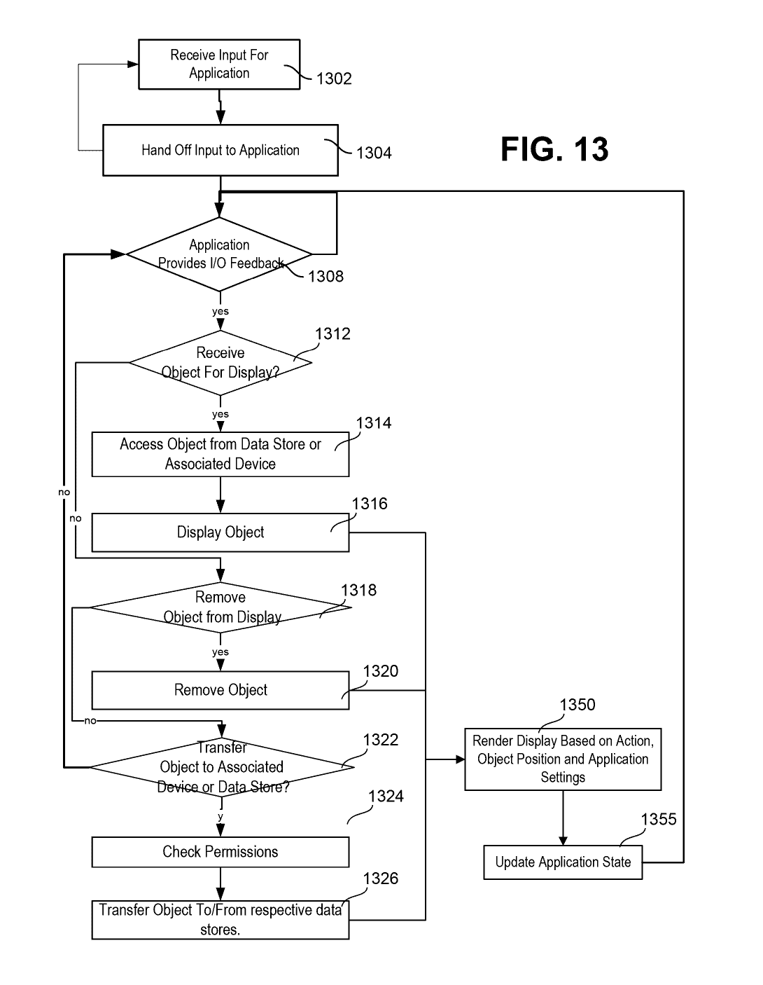

FIG. 13 illustrates one embodiment for performing step 1214 of FIG. 12 on device 100 or service host 602. At step 1302, input to the interactive service 229 is received from the associated processing device. At step 1304, input from the associated processing device is handed off from the interactive service to the interactive application. Service 229 may provide the input received to an application on device 100 or service host 602, depending on whether service 229a or 229b is utilized. In response to the input, the interactive application may provide input or output feedback to the interactive service at 1308. If no feedback is provided, the method waits for additional feedback input from step 1304. At 1308, input from a respective associated device is received and the input may direct service 229 to perform any of a number of actions between device 100 and/or the associated devices. An exemplary action may be, at 1312, to receive an object for display in the display area. If a display action is determined at 1312, then the object is accessed from a data store associated with the user the object at 1314 and the object is displayed at 1316 and the balance of the display area is updated at 1350. Finally the service communicates the action to the application to update the application state at 1355. Another exemplary action may be to remove an object from the display area 120 at 1318. If this action detected at 1318, then the object is removed 1320 and the balance of the display in the display area 120 is rendered at 1350 based on the trigger, object position, and application settings. Yet another possible action at 1322 may be to transfer an object from one user to another—either to a user's associated device or to a user data store. If, at 1322, the action is transfer an object, the permissions may be checked at 1324, and if the permissions pass, then the object can be transferred from one user data store to another at 1326. Again, the display is rendered at 1350 in accordance with the trigger object position, and application settings. In all cases the application stays updated at 1355 and the application returns to step 1308 to await another action.

FIG. 14 illustrates an exemplary computer implemented method for performing step 1224 in FIG. 12 where users are interacting with an interaction application using inputs to the detection area 122. At step 1402, trigger zones are established. Trigger zones can be two or three dimensional interaction zones around any particular area in the display area 120 and/or detection area 122 within which interactions by user can be provided. At step 1404, users who are proximate to the device may participate with the interactive application are identified. Identification may be performed in any number of way, including biometric identification or allowing user to input a password on a displayed interface in the display area 120. At 1406, an application interface is displayed on the surface 50 in the display area 120. Once an interface (if any) is displayed at 1406, steps 1218 and 1220 of FIG. 12 are performed then performed to determine whether an object or gesture is performed in a trigger zone. If so, then the object or gesture is determined at 1220.

In interactive application, an exemplary action may be, at 1412, to receive an object for display in the display area. If a display action is determined at 1412, then the object is accessed from a data store associated with the user the object at 1214 and the object is displayed at 1416 and the balance of the display area is updated at 1450. Finally the service communicates the action to the application to update the application state at 1455. Another exemplary action may be to remove an object from the display area 120 at 1418. If this action detected at 1418, then the object is removed 1420 and the balance of the display in the display area 120 is rendered at 1450 based on the trigger, object position, and application settings. Yet another possible action at 1422 may be to transfer an object from one user to another—either to a user's associated device or to a user data store. If, at 1422, the action is transfer an object, the permissions may be checked at 1424, and if the permissions pass, then the object can be transferred from one user data store to another at 1426. Again, the display is rendered at 1450 in accordance with the trigger object position, and application settings. In all cases the application stays updated at 1455 and the application returns to step 1218 to await another action.

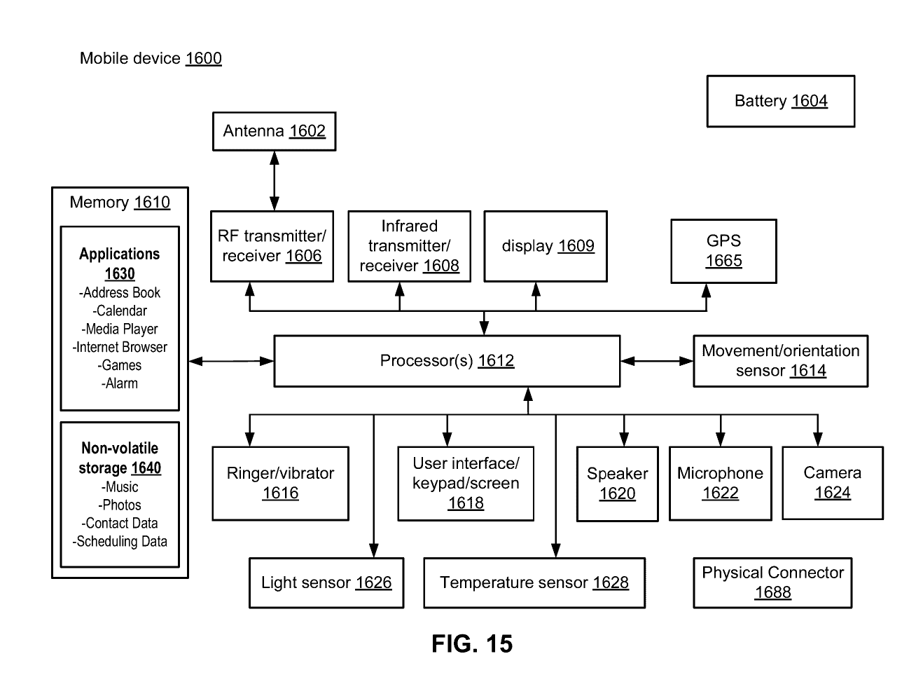

FIG. 15 is a block diagram of one embodiment of a mobile device 1600 which may serve as an associated processing device. Mobile devices may include laptop computers, pocket computers, mobile phones, HMDs, personal digital assistants, and handheld media devices that have been integrated with wireless receiver/transmitter technology.

Mobile device 1600 includes one or more processors 1612 and memory 1610. Memory 1610 includes applications 1630 and non-volatile storage 1640. Memory 1610 can be any variety of memory storage media types, including non-volatile and volatile memory. A mobile device operating system handles the different operations of the mobile device 1600 and may contain user interfaces for operations, such as placing and receiving phone calls, text messaging, checking voicemail, and the like. The applications 1630 can be any assortment of programs, such as a camera application for photos and/or videos, an address book, a calendar application, a media player, an internet browser, games, an alarm application, and other applications. The non-volatile storage component 1640 in memory 1610 may contain data such as music, photos, contact data, scheduling data, and other files.

The one or more processors 1612 are in communication with a see-through display 1609. The see-through display 1609 may display one or more virtual objects associated with a real-world environment. The one or more processors 1612 also communicates with RF transmitter/receiver 1606 which in turn is coupled to an antenna 1602, with infrared transmitter/receiver 1608, with global positioning service (GPS) receiver 1665, and with movement/orientation sensor 1614 which may include an accelerometer and/or magnetometer. RF transmitter/receiver 1608 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 1612 further communicate with a ringer/vibrator 1616, a user interface keypad/screen 1618, a speaker 1620, a microphone 1622, a camera 1624, a light sensor 1626, and a temperature sensor 1628. The user interface keypad/screen may include a touch-sensitive screen display.

The one or more processors 1612 controls transmission and reception of wireless signals. During a transmission mode, the one or more processors 1612 provide voice signals from microphone 1622, or other data signals, to the RF transmitter/receiver 1606. The transmitter/receiver 1606 transmits the signals through the antenna 1602. The ringer/vibrator 1616 is used to signal an incoming call, text message, calendar reminder, alarm clock reminder, or other notification to the user. During a receiving mode, the RF transmitter/receiver 1606 receives a voice signal or data signal from a remote station through the antenna 1602. A received voice signal is provided to the speaker 1620 while other received data signals are processed appropriately.

Additionally, a physical connector 1688 may be used to connect the mobile device 1600 to an external power source, such as an AC adapter or powered docking station, in order to recharge battery 1604. The physical connector 1688 may also be used as a data connection to an external computing device. The data connection allows for operations such as synchronizing mobile device data with the computing data on another device.

The disclosed technology is operational with numerous other general purpose or special purpose computing system environments or configurations. Examples of well-known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

For purposes of this document, reference in the specification to “an embodiment,” “one embodiment,” “some embodiments,” or “another embodiment” may be used to describe different embodiments and do not necessarily refer to the same embodiment.

For purposes of this document, the term “set” of objects refers to a “set” of one or more of the objects.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

### Exemplary Embodiments

In one aspect, the technology includes an interactive integrated processing system, comprising: a display projector in a housing, the display projector adapted to display an interface in a display area on a supporting surface; an RGB camera; an infrared emitter and infrared detector, wherein the RGB camera and the infrared detector each have a field of view, each field of view encompassing a detection area including at least the display area; a communication interface; and a processor and memory including code operable to instruct the processor to receive input from one or more associated devices via the communication interface, the input comprising at least data to be shared in the display area, and provide an output in the display area of the data to be shared based on input instructions from the one or more associated devices.

Additional aspects of the technology include any of the foregoing embodiments wherein the code is operable to instruct the processor to receive input manipulating data in the display area via the detection area.

Another aspect of the technology includes any of the aforementioned embodiments wherein the code is operable to detect one or more user gestures manipulating data in the display area, at least one gesture manipulating data projected as a display object in the display area.

Additional aspects of the technology include any of the foregoing embodiments wherein the code is operable to instruct the processor to control the display projector to render an interface in the display area, the interface configured to manipulate the data shared in the display area.

Additional aspects of the technology include any of the foregoing embodiments wherein the code is operable to identify one or more users proximate to the device and associate the data shared in the display area with the one or more users.

Additional aspects of the technology include any of the foregoing embodiments wherein the code is operable to receive input comprising a transfer data input and to transfer the transfer data from one user data store to another user data store.

Additional aspects of the technology include any of the foregoing embodiments wherein the code is operable to provide an interaction service configured to identify the one or more associated devices and associate the one or more associated devices with an identified user of the device.

Additional aspects of the technology include any of the foregoing embodiments wherein the code is operable to receive the input from the one or more associated devices via a host processing device, the input from the host processing device including an identification of a user associated with each of the one or more processing devices.

Another aspect of the technology includes a computer implemented method facilitating interaction between multiple users in a projection area. The method includes rendering a display area on a supporting surface using an interaction device having projector provided in a housing on the supporting surface; detecting one or more inputs the display area utilizing sensors provided in the housing, each of the sensors having a field of view defining a detection area including at least the display area; receiving input to an interactive service via a communication interface provided in the housing, the input adapted to share information in the display area, the input received from a companion processing device associated with a user; and rendering an output in the display area responsive to the input, the output including one or more display objects representing interaction activity between at least the companion processing device and the interaction device.

Additional aspects of the technology include any of the foregoing embodiments wherein the detecting includes receiving input comprising a user gesture manipulating data using the one or more display object in the display area via the detection area.

Additional aspects of the technology include any of the foregoing embodiments wherein the detecting includes one or more user gestures adapted to transfer data from one user data store to another user data store.

Additional aspects of the technology include any of the foregoing embodiments wherein the rendering an output includes displaying a shared display object provided by a user from at least one companion processing device.

Additional aspects of the technology include any of the foregoing embodiments wherein the method further includes rendering a control interface in the display area, the interface configured to manipulate data shared in the display area.

Additional aspects of the technology include any of the foregoing embodiments further including identifying one or more users proximate to the device and associated data shared in the display area with the one or more users.

Additional aspects of the technology include any of the foregoing embodiments further including receiving input via the detection area comprising a transfer data input between users and transferring the transfer data from one user data store to another user data store.

Additional aspects of the technology include any of the foregoing embodiments wherein said receiving includes receiving the input from the one or more companion processing devices via a host processing device, the input from the host processing device including an identification of a user associated with each of the one or more companion processing devices.

Another aspect of the technology is an apparatus, comprising: a housing adapted to be supported on a surface; a processor in the housing; a projector in the housing, the projector configured to render a display area on the surface; a first type of image sensor and a second type of image sensor in the housing, each image sensor having a field of view of at least the display area; and a memory in the housing, the memory including code instructing the processor to provide an interaction service to receive input from at least a first user and a second user, each user having at least an associated data store, the code operable to instruct the processor to receive input to manipulate objects in the data store via the display area on the surface.

Additional aspects of the technology include any of the foregoing embodiments wherein the code is operable to receive data from one of the associated data stores and to render in the display area a display object representing the data.

Additional aspects of the technology include any of the foregoing embodiments wherein the code is operable to receive input comprising a gesture manipulating the display object to manipulate data relative to the one of the associated data stores.

Additional aspects of the technology include any of the foregoing embodiments wherein the code is operable to transfer data between associated data stores responsive to the gesture.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An interactive integrated processing system, comprising:
a display projector in a housing, the display projector adapted to display an interface in a display area on a supporting surface;
an RGB camera;
an infrared emitter and infrared detector, wherein the RGB camera and the infrared detector each have a field of view, each field of view encompassing a detection area including at least the display area;
a communication interface; and
a processor and memory including code operable to instruct the processor to receive input from one or more associated devices via the communication interface, the input comprising at least data to be shared in the display area, and provide an output in the display area of the data to be shared based on input instructions from the one or more associated devices.

2. The system of claim 1 wherein the code is operable to instruct the processor to receive input manipulating data in the display area via the detection area.

3. The system of claim 1 wherein the code is operable to detect one or more user gestures manipulating data in the display area, at least one gesture manipulating data projected as a display object in the display area.

4. The system of claim 1 wherein the code is operable to instruct the processor to control the display projector to render an interface in the display area, the interface configured to manipulate the data shared in the display area.

5. The system of claim 1 wherein the code is operable to identify one or more users proximate to the device and associate the data shared in the display area with the one or more users.

6. The system of claim 1 wherein the code is operable to receive input comprising a transfer data input and to transfer the transfer data from one user data store to another user data store.

7. The system of claim 1 wherein the code is operable to provide an interaction service configured to identify the one or more associated devices and associate the one or more associated devices with an identified user of the device.

8. The system of claim 1 wherein the code is operable to receive the input from the one or more associated devices via a host processing device, the input from the host processing device including an identification of a user associated with each of the one or more processing devices.

9. A computer implemented method facilitating interaction between multiple users in a projection area, comprising:
rendering a display area on a supporting surface using an interaction device having projector provided in a housing on the supporting surface;
detecting one or more inputs the display area utilizing sensors provided in the housing, each of the sensors having a field of view defining a detection area including at least the display area;
receiving input to an interactive service via a communication interface provided in the housing, the input adapted to share information in the display area, the input received from a companion processing device associated with a user; and
rendering an output in the display area responsive to the input, the output including one or more display objects representing interaction activity between at least the companion processing device and the interaction device.

10. The method of claim 9 wherein the detecting includes receiving input comprising a user gesture manipulating data using the one or more display object in the display area via the detection area.

11. The method of claim 10 wherein the detecting includes one or more user gestures adapted to transfer data from one user data store to another user data store.

12. The method of claim 10 wherein the rendering an output includes displaying a shared display object provided by a user from at least one companion processing device.

13. The method of claim 9 wherein the method further includes rendering a control interface in the display area, the interface configured to manipulate data shared in the display area.

14. The method of claim 9 further including identifying one or more users proximate to the device and associated data shared in the display area with the one or more users.

15. The method of claim 9 further including receiving input via the detection area comprising a transfer data input between users and transferring the transfer data from one user data store to another user data store.

16. The method of claim 9 wherein said receiving includes receiving the input from the one or more companion processing devices via a host processing device, the input from the host processing device including an identification of a user associated with each of the one or more companion processing devices.

17. An apparatus, comprising:
a housing adapted to be supported on a surface;
a processor in the housing;
a projector in the housing, the projector configured to render a display area on the surface;
a first type of image sensor and a second type of image sensor in the housing, each image sensor having a field of view of at least the display area; and
a memory in the housing, the memory including code instructing the processor to provide an interaction service to receive input from at least a first user and a second user, each user having at least an associated data store, the code operable to instruct the processor to receive input to manipulate objects in the data store via the display area on the surface.

18. The apparatus of claim 17 wherein the code is operable to receive data from one of the associated data stores and to render in the display area a display object representing the data.

19. The apparatus of claim 18 wherein the code is operable to receive input comprising a gesture manipulating the display object to manipulate data relative to the one of the associated data stores.

20. The apparatus of claim 19 wherein the code is operable to transfer data between associated data stores responsive to the gesture.
